(19) United States
(12) Patent Application Publication
(10) Pub. No.: US 2017/0291850 A1
(43) Pub. Date: Oct. 12, 2017

(54) MICRO-HOLE ARRAY AND METHOD FOR MANUFACTURING SAME

(71) Applicant: NIPPON ELECTRIC GLASS CO., LTD., Otsu-shi, Shiga (JP)

(72) Inventors: Masanori WADA, Otsu-shi (JP); Toru HIRAO, Otsu-shi (JP)

(21) Appl. No.: 15/503,492

(22) PCT Filed: Oct. 29, 2015
(86) PCT No.: PCT/JP2015/080544

§ 371 Date: Feb. 13, 2017

(30) Foreign Application Priority Data
Jan. 6, 2015 (JP) 2015-000865

(51) Int. Cl. C03C 23/00; B23K 26/122; B23K 26/00; B23K 26/382; B23K 26/402

(52) U.S. Cl. CPC C03C 23/0025; B23K 26/382; B23K 26/402; B23K 26/009; B23K 26/122; B23K 2203/54

(57) ABSTRACT

Provided are a micro-hole array capable of accurately holding optical fibers or the like and a method for manufacturing a micro-hole array by which micro-holes having high shape accuracy can be formed. A micro-hole array has thirty or more through holes 3 formed per cm² in a glass plate 2 with a thickness of 0.5 mm to 5 mm, both inclusive, the through holes 3 each having a cylindrical portion 5 having a cylindricity of 5% or less of a hole diameter d₁ of the through hole 3.

### TECHNICAL FIELD

The present invention relates to micro-hole arrays and methods for manufacturing the same.

### BACKGROUND ART

A micro-hole array is known as a member for aligning and holding optical elements, such as optical fibers, with high accuracy. Patent Literature 1 discloses a micro-hole array in which cylindrical portions each including a hole for holding an optical fiber or the like are made of resin and the outer peripheries of the cylindrical portions are held by a body matrix made of ceramic or the like.

Patent Literature 2 discloses that in a microfluidic bead array a microstructural pattern for fixing beads is formed by the laser-induced backside wet etching process (LIBWE process).

### CITATION LIST

### Patent Literature

[PTL 1]

JP-A-2003-107283

### SUMMARY OF INVENTION

### Technical Problem

In Patent Literature 1, since the cylindrical portions for holding optical fibers or the like are made of resin, the shape accuracy of the cylindrical portions cannot be increased. Therefore, the optical fibers or the like cannot be accurately held within the cylindrical portions, which presents a problem that the positional accuracy of the optical fibers or the like cannot be increased.

The LIBWE process is a process in which with a laser light-absorbable liquid in contact with an object to be processed, the liquid is irradiated with laser light to cut the object using shock wave generated by expansion/contraction of bubbles in the liquid. In forming a micro-hole by the LIBWE process, there is a problem that chips produced by the cutting process are likely to adhere to the wall surface of the micro-hole, so that the micro-hole cannot be formed with high shape accuracy.

An object of the present invention is to provide a micro-hole array that, in holding optical fibers or the like, can accurately hold the optical fibers or the like, and a method for manufacturing a micro-hole array by which micro-holes having high shape accuracy can be formed.

### Solution to Problem

The present invention is characterized by a micro-hole array having thirty or more through holes formed per cm² in a glass plate with a thickness of 0.5 mm to 5 mm, both inclusive, the through holes each having a cylindrical portion having a cylindricity of 5% or less of a hole diameter of the through hole.

In the present invention, the hole diameter is preferably 50% or less of the thickness of the glass plate.

The through holes are preferably formed to extend in a thickness direction of the glass plate.

The glass plate is preferably a silica glass plate.

The through holes are, for example, through hole for inserting and holding optical fibers therein.

A manufacturing method according to the present invention is characterized by a method for manufacturing a micro-hole array in which a plurality of through holes are formed in a glass plate having a first principal surface and a second principal surface by laser irradiation to pass through the glass plate from the first principal surface to the second principal surface, the method including the steps of: bringing the first principal surface into contact with a liquid transparent to laser; and using pulsed laser having a duration of 10 picoseconds or less as the laser to irradiate the glass plate with the laser from the second principal surface side to focus the laser on portions of the first principal surface in contact with the liquid, thus forming the through holes.

The laser preferably has a wavelength of 1000 nm or more.

The laser is preferably femtosecond laser.

The liquid is, for example, a petroleum solvent in which hydrogen is at least partly substituted with fluorine.

### Advantageous Effects of Invention

When the micro-hole array of the present invention is used as a micro-hole array for holding optical fibers or the like, the optical fibers or the like can be accurately held.

According to the manufacturing method of the present invention, micro-holes having high shape accuracy can be efficiently formed.

### BRIEF DESCRIPTION OF DRAWINGS

FIG. 1 is a schematic plan view showing a micro-hole array according to an embodiment of the present invention.

FIG. 2 is a schematic cross-sectional view showing a micro-hole in the micro-hole array according to the embodiment of the present invention.

FIG. 3 is a schematic perspective view for illustrating cylindricity.

FIG. 4 is a schematic cross-sectional view for illustrating a method for manufacturing a micro-hole array according to an embodiment of the present invention.

### DESCRIPTION OF EMBODIMENTS

Hereinafter, a description will be given of preferred embodiments. However, the following embodiments are merely illustrative and the present invention is not limited to the following embodiments. Throughout the drawings, members having substantially the same functions may be referred to by the same reference characters.

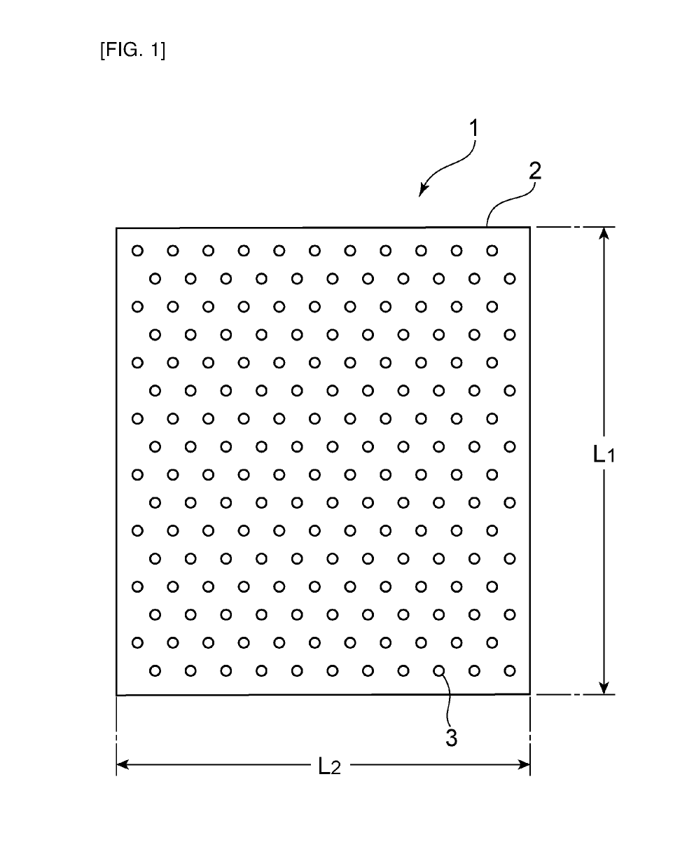

FIG. 1 is a schematic plan view showing a micro-hole array according to an embodiment of the present invention. A micro-hole array 1 according to this embodiment is formed by forming multiple through holes 3 in a glass plate 2. In this embodiment, the length L₁ of the glass 2 in the longitudinal direction is 20 mm and the length L₂ thereof in the transverse direction is 20 mm. Eleven through holes 3 are arranged in the transverse direction and sixteenth through holes 3 are arranged in the longitudinal direction. Therefore, in this embodiment, 176 through holes 3 are formed in the glass plate 2 and 44 through holes are formed per cm² in the glass plate 2. Hence, thirty or more through holes 3 are formed per cm² in the glass plate 2. The upper limit of the number of through holes 3 is not particularly limited but is generally not more than 1000.

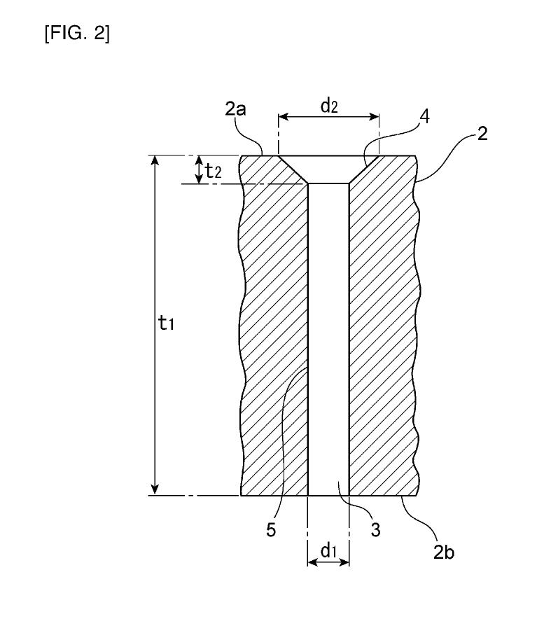

FIG. 2 is a schematic cross-sectional view showing a micro-hole in the micro-hole array according to the embodiment of the present invention. As shown in FIG. 2, each through hole 3 is formed to pass through the glass plate 2 from the first principal surface 2a to the second principal surface 2b. In this embodiment, the through holes 3 are formed to extend in a direction of the thickness t₁ of the glass plate 2. The present invention is not limited to this and the through holes 3 may be formed in a direction at an angle to the direction of the thickness t₁ of the glass plate 2.

In this embodiment, the thickness t₁ of the glass plate 2 is 1 mm. In this embodiment, the through holes 3 have a hole diameter d₁ of 125 μm. Therefore, in this embodiment, the hole diameter d₁ of the through holes 3 is 50% or less of the thickness t₁ of the glass plate 2.

In the present invention, the hole diameter d₁ of the through holes 3 is preferably 50% or less of the thickness t₁ of the glass plate 2 and more preferably 20% or less thereof. Setting the hole diameter d₁ within these ranges enables, when inserting and holding optical fibers or the like into the through holes 3, the optical fibers or the like to be accurately held therein without causing misalignment. Its lower limit is not particularly limited but is preferably not less than 1% of the thickness t₁ of the glass plate 2.

Micro-holes in the micro-hole array of this embodiment are formed of the through holes 3 formed in the glass plate 2. Therefore, as compared to the case where micro-holes are formed by resin, micro-holes can be formed with high shape accuracy.

In this embodiment, a tapered portion 4 is formed in the first principal surface 2a side. The tapered portion 4 is formed in order that when an optical fiber or the like is inserted into the through hole 3 from the first principal surface 2a side, the optical fiber or the like can be easily inserted thereinto. The tapered portion 4 has a maximum diameter d₂ of 300 μm. Furthermore, the tapered portion 4 has a thickness t₂ of 80 μm. A cylindrical portion 5 having a hole diameter d₁ is formed between the second principal surface 2b and the tapered portion 4. The hole diameter d₁ of the through hole 3 refers to the hole diameter of the cylindrical portion 5. In this embodiment, the cylindrical portion 5 has a cylindricity of 5% or less of the hole diameter d₁ of the through hole 3.

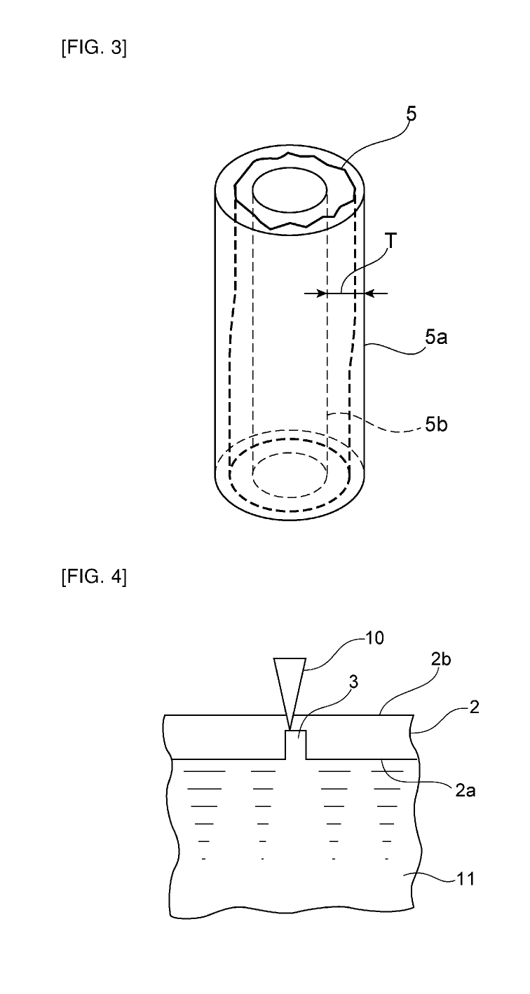

FIG. 3 is a schematic perspective view for illustrating cylindricity. As shown in FIG. 3, the cylindricity is defined as the difference T between the diameter of a minimum circumscribed cylinder 5a of the cylindrical portion 5 and the diameter of a maximum inscribed cylinder 5b thereof. Such a cylindricity can be determined by, for example, a roundness/cylindrical form measuring instrument or the like.

In the present invention, the cylindrical portion 5 has a cylindricity of 5% or less of the hole diameter d₁ of the through hole 3. Setting the cylindricity within this range enables, when inserting optical fibers or the like into the through holes 3, the optical fibers or the like to be prevented from being inclined and misaligned in the through holes 3. Therefore, the optical fibers or the like can be accurately held. The cylindricity is more preferably 2% or less. No particular limitation is placed on the lower limit of the cylindricity.

In the present invention, the thickness t₁ of the glass plate 2 is 0.5 mm to 5 mm, both inclusive. Setting the thickness t₁ within this range enables optical fibers or the like to be easily inserted into the through holes 3 and, in addition, enables chips produced during perforation of through holes 3 to be easily discharged, thus preventing the through holes 3 from being clogged. The thickness t₁ of the glass plate 2 is more preferably 4 mm or less.

FIG. 4 is a schematic cross-sectional view for illustrating a method for manufacturing a micro-hole array according to an embodiment of the present invention. In the manufacturing method of this embodiment, through holes 3 are formed in a glass plate 2 having a first principal surface 2a and a second principal surface 2b by laser irradiation to pass through the glass plate 2 from the first principal surface 2a to the second principal surface 2b.

As shown in FIG. 4, a transparent liquid 11 is brought into contact with the first principal surface 2a of the glass plate 2. The transparent liquid 11 is a liquid transparent to laser light 10. The term “transparent” used herein means that the liquid has a low absorptance of laser light 10. Specifically, the absorptance of laser light 10 by the liquid is preferably 10% or less, more preferably 5% or less, and particularly preferably 1% or less.

The manufacturing method of the present invention is different from the LIBWE process in that the liquid having a low absorptance of laser light 10 is used. As described previously, the LIBWE process is a process in which a liquid opaque to laser light is used, bubbles of the liquid are expanded/contracted by irradiation of laser light, and an object is cut using shock wave thus generated. Therefore, according to the LIBWE process, chips produced by the cutting process vigorously strike the wall surfaces of the micro-holes due to the shock wave and are therefore likely to adhere to the wall surfaces of the micro-holes. Contrariwise, in the present invention, a liquid having a low absorptance of laser light 10 is used, which does not cause any shock wave due to the liquid. Therefore, glass chips produced by the formation of the through holes 3 can be efficiently discharged from the through holes 3 to the transparent liquid 11.

Specific examples of the transparent liquid 11 include water and a petroleum solvent in which hydrogen is at least partly substituted with fluorine. Specific examples of the petroleum solvent include methylethylketone and acetone in both of which hydrogen is at least partly substituted with fluorine.

The wavelength of the laser light 10 is preferably a wavelength less absorbed by the glass plate 2. From this viewpoint, the wavelength of the laser light 10 is preferably 1000 nm or more, more preferably 1300 nm or more, and still more preferably 1500 nm or more. No particular limitation is placed on the upper limit of the wavelength of the laser light 10, but the wavelength of the laser light 10 is generally not more than 2000 nm. Note that in this embodiment a silica glass plate is used as the glass plate 2. When the glass plate 2 is a silica glass, it has low light absorption in a wavelength range of 2000 nm or less, which facilitates processing using the laser light 10.

In this embodiment, the laser light 10 is pulsed laser having a duration of 10 picoseconds or less. The laser light 10 is more preferably ultrashort pulsed laser having a duration of 1 picosecond or less and more preferably femtosecond laser. The use of such laser having a small pulse width causes a multiphoton absorption phenomenon and thus enables abrasion processing without diffusing heat into surrounding portions.

In this embodiment, as shown in FIG. 4, each through hole 3 is formed by applying laser light 10 from the second principal surface 2b side to focus the laser light 10 on a portion of the first principal surface 2a in contact with the transparent liquid 11 and move the laser light 10 with scanning toward the second principal surface 2b. Therefore, the laser light 10 is applied from the back side.

If a through hole 3 is formed by applying laser light 10 from the second principal surface 2b side to focus the laser light 10 on the second principal surface 2b and moving the laser light 10 with scanning toward the first principal surface 2a, laser light 10 having a large diameter located above the focal point of the laser light 10 would be applied to the wall surface of the formed through hole 3 (on the second principal surface 2b side) for a long time, thus expanding the hole diameter of the through hole 3 and resulting in failure to form the through hole 1 with high shape accuracy. Unlike this, when, as shown in FIG. 4, the laser light 10 is applied from the second principal surface 2b side to focus the laser light 10 on the portion of the first principal surface 2a and moved with scanning toward the second principal surface 2b, the wall surface of the formed through hole 3 (on the second principal surface 2b side) is prevented from being irradiated with the laser light 10 for a long time, which enables the through hole 3 to be formed with high shape accuracy.

As thus far described, in this embodiment, laser light 10 is applied from the second principal surface 2b side to focus the laser light 10 on portions of the first principal surface 2a in contact with the transparent liquid 11, so that through holes 3 can be formed with high shape accuracy. Furthermore, the transparent liquid 11 enters the processed portions by capillarity, so that glass chips produced by the processing can be efficiently removed by the transparent liquid 11. Therefore, glass chips produced by the processing can be prevented from adhering to the wall surfaces of the through holes 3, which enables the through holes 3 to be formed with higher shape accuracy. The focal point of the laser light 10 may be moved with scanning, for example, in a spiral manner, so that the through holes 3 can be formed with high shape accuracy.

Hence, according to the manufacturing method of the present invention, the micro-hole array of the present invention in which each through hole 3 has a cylindrical portion having a cylindricity of 5% or less of the hole diameter of the through hole 3 can be efficiently manufactured.

Although FIG. 4 does not show the tapered portion 4 shown in FIG. 2, the tapered portion 4 can also be formed, during the formation of the through hole 3, by moving the focal point of the laser light 10 with scanning to form the tapered portion 4.

Although the above description has been given of an application of the micro-hole array of the present invention in which optical fibers or the like are inserted and fixed into the through holes, that is, the micro-holes, the present invention is not limited to this application. For example, the micro-hole array can also be used for an application in which the micro-holes are used as flow channels, as disclosed in Patent Literature 2.

### REFERENCE SIGNS LIST

1 . . . micro-hole array

2 . . . glass plate

2a . . . first principal surface

2b . . . second principal surface

3 . . . through hole

4 . . . tapered portion

5 . . . cylindrical portion

5a . . . minimum circumscribed cylinder

5b . . . maximum circumscribed cylinder

10 . . . laser light

11 . . . transparent liquid

d₁ . . . hole diameter of through hole

d₂ . . . maximum diameter of tapered portion

t₁ . . . thickness of glass plate

t₂ . . . thickness of tapered portion

T . . . cylindricity

1. A micro-hole array having thirty or more through holes formed per cm² in a glass plate with a thickness of 0.5 mm to 5 mm, both inclusive, the through holes each having a cylindrical portion having a cylindricity of 5% or less of a hole diameter of the through hole.

2. The micro-hole array according to claim 1, wherein the hole diameter is 50% or less of the thickness of the glass plate.

3. The micro-hole array according to claim 1, wherein the through holes are formed to extend in a thickness direction of the glass plate.

4. The micro-hole array according to claim 1, wherein the glass plate is a silica glass plate.

5. The micro-hole array according to claim 1, wherein the through holes are through holes for inserting and holding optical fibers therein.

6. A method for manufacturing a micro-hole array in which a plurality of through holes are formed in a glass plate having a first principal surface and a second principal surface by laser irradiation to pass through the glass plate from the first principal surface to the second principal surface, the method comprising the steps of:
bringing the first principal surface into contact with a liquid transparent to laser; and
using pulsed laser having a duration of 10 picoseconds or less as the laser to irradiate the glass plate with the laser from the second principal surface side to focus the laser on portions of the first principal surface in contact with the liquid, thus forming the through holes.

7. The method for manufacturing a micro-hole array according to claim 6, wherein the laser has a wavelength of 1000 nm or more.

8. The method for manufacturing a micro-hole array according to claim 6, wherein the laser is femtosecond laser.

9. The method for manufacturing a micro-hole array according to claim 6, wherein the liquid is a petroleum solvent in which hydrogen is at least partly substituted with fluorine.
